(19) United States
(12) Patent Application Publication
(10) Pub. No.: US 2026/0127918 A1
(43) Pub. Date: May 7, 2026

(54) AUTOMATIC VEHICLE GROSS WEIGHT & INSPECTION REPORTING

(71) Applicant: Stack AV Co., Mount Pleasant, PA (US)

(72) Inventor: Jonathan Michael BONTE, Farmington Hills, MI (US)

(73) Assignee: Stack AV Co., Mount Pleasant, PA (US)

(21) Appl. No.: 18/938,914

(22) Filed: Nov. 6, 2024

(51) Int. Cl. G07C 5/00; G01G 19/03; G01G 19/62; G07C 5/08

(52) U.S. Cl. CPC G07C 5/008; G01G 19/03; G01G 19/62; G07C 5/085

(57) ABSTRACT

A method of transmitting vehicle information, performed at least in part at a vehicle comprising one or more sensors, one or more processors, and memory is provided. The method includes storing vehicle information on the memory; detecting, by the one or more sensors, an optical code, the optical code having encoded information; decoding, by the one or more processors, the encoded information; identifying a remote computing system based on the decoded information; and transmitting a signal comprising the vehicle information from the vehicle to the identified remote computing system.

### FIELD

This disclosure relates generally to systems and methods of transmitting vehicle information, and more specifically, to transmitting vehicle information based on optical codes that are detected by vehicle sensors.

### BACKGROUND

Many trucks and commercial vehicles are required to stop at weigh stations in accordance with state and local regulations. Weigh stations are designed to prevent overweight vehicles from damaging roads and bridges. Additionally, state and/or local authorities may check freight and vehicle paperwork, tax compliance, and may perform vehicle inspections at weigh stations. As such, weigh stations are important for the safe operation of commercial vehicles.

According to known weigh station methods, trucks and commercial vehicles are required to pull off the side of a road or exit off a highway to access weigh stations. Recently, improvements have been made to weigh station technology that allow some vehicles to bypass weigh stations altogether. These technologies involve the use of a transponder or other on-board accessories to transmit information to a participating weigh stations. However, not all weigh stations support the use of these technologies, posing an inconvenience for commercial drivers. These technologies also require that the weigh station be outfitted with receivers to support various types of transponders/on-board devices, which can be costly to implement and can slow down implementation by states and municipalities.

### SUMMARY

As described above, known systems and methods of acquiring weight or safety information from trucks or commercial vehicles require vehicles to pull off a road and/or are costly and burdensome to implement into existing infrastructure. Accordingly, there is a need for improved systems and methods that allow for weight and safety information to be automatically, reliably, efficiently, and flexibly be transmitted from trucks and other commercial vehicles. Described herein are systems and methods that may address one or more of these needs.

Described herein are systems and methods for automatically transmitting vehicle information to a weigh station or other location. The systems and methods described herein may be inexpensive to implement and may allow for drivers to comply with vehicle information sharing requirements without needing to pull off the road.

Systems and methods for automatically transmitting vehicle information based on detected optical codes are disclosed herein. Information indicating a vehicle's inspection results, cargo, and/or the weight may be stored on memory of a vehicle's computing system. This information may have been previously measured at a prior weigh station and stored on the vehicle, or may be measured based (e.g., previously and/or in real time) by a weighing system or other sensor system built into the vehicle. One or more optical codes, such as QR codes, may be provided in proximity to the vehicle, for example on the roadside or in other locations in which the commercial vehicle may operate. The optical codes may be detectable by one or more optical sensors on the vehicle (e.g. one or more cameras). This sensor technology, in addition to the vehicle computing system, may already be present in most modern vehicles, especially autonomous or semi-autonomous commercial vehicles. For example, an autonomous vehicle may already be equipped with one or more cameras for used by its autonomous navigation systems, and these same one or more cameras may be used for optical code detection as described herein. Accordingly, the systems and methods described herein may advantageously require few modifications to existing vehicles for implementation, thus reducing the difficulties and costs associated with widespread implementation. The optical codes may be printed on any suitable medium (e.g., on signage) anywhere vehicle information is desired to be collected, such as on a side of a road and/or in front of an existing weigh station. Thus, the optical codes may be easily and inexpensively implemented into existing infrastructure as well.

The optical codes may contain encoded information that identifies a remote computing system (e.g., identifies a network address for electronic communication with a computing system associated with a weigh station). One or more processors of the vehicle's computing system may decode the encoded information, which may allow it to identify the remote computing system that is associated with the weigh station. By decoding the identifying information in the optical code, a communicative link can be established between the vehicle's computing system and the remote computing system. This can allow for information to be exchanged between both computing systems through wireless and/or cellular signals, for example. In some examples, a vehicle may be configured to transmit vehicle information to a remote computing system automatically upon detecting an optical code. Therefore, vehicle information can be transmitted rapidly with little to no effort required from the driver, helping to reduce transit times by eliminating the need for the driver to pull over. The systems and methods described herein may also promote roadway safety by reducing the number of vehicles that skip weigh stations.

In some embodiments, a method of transmitting vehicle information is provided, the method performed at least in part at a vehicle comprising one or more sensors, one or more processors, and memory. In some embodiments, the method comprises: storing vehicle information on the memory; detecting, by the one or more sensors, an optical code, the optical code comprising encoded information; decoding, by the one or more processors, the encoded information; identifying a remote computing system based on the decoded information; and transmitting a signal comprising the vehicle information from the vehicle to the identified remote computing system.

In some embodiments of the method, the vehicle information comprises one or more of vehicle weight information, vehicle height information, cargo information, or vehicle inspection information.

In some embodiments of the method, the vehicle information comprises vehicle height information, and the optical code is located along a roadway that passes under an overpass.

In some embodiments of the method, the optical code is an ArUco, a QR code, a barcode, or a bit code.

In some embodiments of the method, the method further comprises establishing a communicative link between the vehicle and the identified remote computing system based on the optical code.

In some embodiments of the method, the communicative link is a peer-to-peer link, a cellular connection, a Bluetooth connection, or a direct wireless communication protocol.

In some embodiments of the method, the method further comprises receiving, by the vehicle, in response to transmitting the signal comprising the vehicle information, a signal from the remote computing system comprising status information.

In some embodiments of the method, the vehicle information comprises vehicle weight information, and the status information indicates that the vehicle weight exceeds a weight limitation.

In some embodiments of the method, the vehicle information comprises cargo information, and the status information indicates that the vehicle is carrying unpermitted cargo.

In some embodiments, a system is provided comprising a vehicle comprising one or more sensors, one or more processors, and memory. The memory may store computer program code executable by the one or more processors to cause the vehicle to: store vehicle information on the memory; detect, by the one or more sensors, an optical code, the optical code comprising encoded information; decode, by the one or more processors, the encoded information; identify a remote computing system based on the decoded information; and transmit a signal comprising the vehicle information from the vehicle to the identified remote computing system.

In some embodiments of the system, the vehicle information comprises vehicle weight information, and wherein the optical code is located on a side of a roadway or bridge.

In some embodiments of the system, the vehicle information comprises vehicle height information, and wherein the optical code is located along a roadway that passes under an overpass.

In some embodiments of the system, the optical code is an ArUco, a QR code, a barcode, or a bit code.

In some embodiments of the system, the vehicle is further caused to establish a communicative link between the vehicle and the identified remote computing system based on the optical code.

In some embodiments of the system, the communicative link is a peer-to-peer link, a cellular connection, a Bluetooth connection, or a direct wireless communication protocol.

In some embodiments of the system, the vehicle is further caused to receive, in response to transmitting the signal comprising the vehicle information, a signal from the remote computing system comprising status information.

In some embodiments of the system, the vehicle information comprises vehicle weight information, and the status information indicates that the vehicle exceeds a weight limitation.

In some embodiments of the system, the vehicle information comprises cargo information, and the status information indicates that the vehicle is carrying unpermitted cargo.

In some embodiments, a non-transitory computer readable storage medium storing one or more programs is provided, the one or more programs comprising instructions, which, when executed by a vehicle comprising one or more sensors, one or more processors, and memory, cause the vehicle to: store vehicle information on the memory; detect, by the one or more sensors, an optical code, the optical code comprising encoded information; decode, by the one or more processors, the encoded information; identify a remote computing system based on the decoded information; and transmit a signal comprising the vehicle information from the vehicle to the identified remote computing system.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary method of transmitting vehicle information, according to some embodiments.

FIG. 2A illustrates a vehicle detecting an optical code, according to some embodiments.

FIG. 2B illustrates a communicative link between a vehicle and a remote computing system, according to some embodiments.

FIG. 3A illustrates an optical code for collecting vehicle height information, according to some embodiments.

FIG. 3B illustrates the display of vehicle status information, according to some embodiments.

FIG. 4 illustrates a computer, according to some embodiments.

### DETAILED DESCRIPTION

Providing herein are systems and methods of transmitting information stored on a computing system of a vehicle, such as weight information, inspection information, or other safety information while requiring minimal effort from vehicle drivers. In some examples, a method of transmitting vehicle information is provided that can be performed on a vehicle having a computing system and one or more sensors, such as an autonomous or semi-autonomous vehicle

A method may include storing vehicle information, such as weight information or vehicle inspection information on memory of the vehicle's computing system. In some examples, the weight information may be provided by a weighing system built onto the vehicle, for instance, on one or more axle sensors of the vehicle. Additionally, or alternatively, the weight information and/or the inspection information may have been obtained from an earlier vehicle inspection or a previous weigh station stop, allowing information to be reused for as long as it accurately characterizes the vehicle's condition.

In some examples, an optical code may be posted on a sign (and/or provided by a dynamic electronic display) near a road or made otherwise visible to a vehicle such that the vehicle's optical sensors are able to detect the optical code as the vehicle approaches or passes by. The optical code may contain encoded identifying information corresponding to a remote computing system (e.g., a computer associated with a weigh station). In response to detecting the optical code, the vehicle's computing system may decode the encoded information to determine the identity of the remote computing system that is to receive vehicle information, thereby allowing the vehicle to establish a communicative link with the remote computing system. Then, a vehicle may transmit part or all of the stored vehicle information to the remote computing device identified in the encoded information, either automatically or responsively to an input from the driver. In this manner, little to no effort is needed from vehicle drivers to comply with vehicle weight and safety reporting requirements, thereby improving compliance with reporting rules and requirements, helping to prevent damage to public roads, and helping to improve overall roadway safety.

As a result of the communicative link that may be established between the vehicle and the remote computing system, the method may also include receiving signals sent by the remote computing device to the vehicle, before and/or in response to the transmission of the vehicle information. The received signals may include information regarding the status of the vehicle, for example, whether the vehicle is in compliance with a weight restriction on a given roadway. In some examples, the received vehicle status information may be displayed to the driver on a display within the vehicle so that the driver is made aware of the vehicle's status. In some examples, the received information may be used to control one or more vehicle systems, for example by causing an overweight autonomous vehicle to automatically exit a roadway, or by causing an autonomous vehicle to automatically navigate in a certain manner based on its weight or height (e.g., to avoid low clearances or roadways with weight limits and/or to modulate vehicle speed based on vehicle weight).

The systems and methods described herein may be suitable for various applications in addition to gathering vehicle weight information. For example, an optical code may be positioned in an any area where the collection of any other vehicle information is desired, such as near an overpass, bridge, or garage entrance. This can, for example, enable the automatic transmission of vehicle height information to/from the vehicle to ensure that there is enough clearance for the vehicle. Further, an optical code may be posted near a loading dock or a roadway, e.g. along a state/county line, to enable the transmission of information to/from vehicles that may be carrying hazardous or unpermitted cargo. Due to the relatively low cost and the compatibility of optical codes with existing infrastructure and vehicle technology, the systems and methods described herein can be easily and efficiently implemented by states and municipalities. This can facilitate the maintenance and longevity of roads while ensuring the safety of the vehicles that travel upon them.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

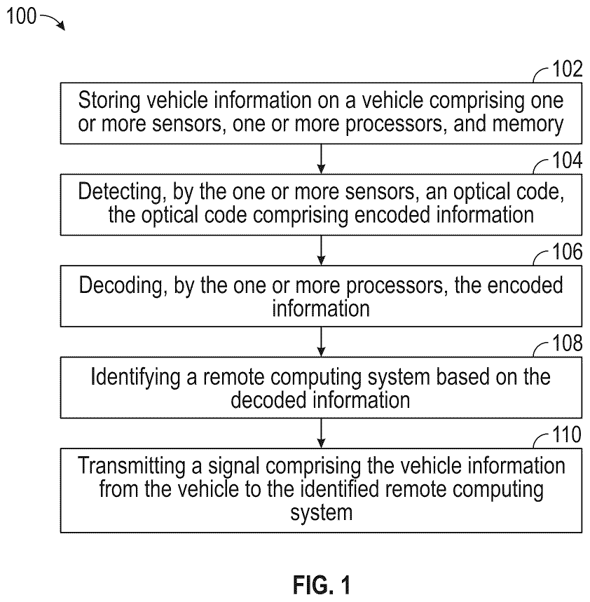

FIG. 1 depicts an exemplary method 100 of transmitting vehicle information, according to some examples. Method 100 may be performed at least in part at a system that includes a vehicle, for example, a truck or commercial vehicle. The vehicle may include a computing system, which may include a central computing module and/or a network of electronic control units that may oversee various functions in the operation of the vehicle. The vehicle's computing system may include one or more processors and memory. The one or more processors may include one or more processing units (e.g., digital circuitry, microcontrollers, microprocessors, embedded processors, central processing units (CPUs), graphics processing units (GPUs), etc.). A vehicle may further include one or more computer readable media storing instructions for performing various operations (e.g., detecting and/or decoding optical codes, and/or transmitting and receiving signals that include vehicle information). The computer readable media can be any medium (e.g., a memory) that can store programs to be executed by the one or more processors of the vehicle.

In some examples, method 100 may be implemented by configuring a vehicle computing system that is typically present in most modern vehicles using any suitable programming technique. In other examples, a vehicle computing system may be installed within a vehicle for implementing method 100. A vehicle may also include one or more sensors, for example, one or more optical sensors, cameras, LIDAR sensors, and/or other sensors suitable for detecting information about surrounding roads, environments, actors, and vehicle conditions. Additionally, the vehicle may include one or more communication devices configured for electronic wireless communication with other systems, for example via cellular communication, WiFi communication, Bluetooth communication, and/or any other suitable electronic communication protocol. In some examples, method 100 may be performed at a vehicle with autonomous or semi-autonomous driving capabilities.

At step 102, method 100 may involve storing vehicle information on memory of the vehicle's computing system. The vehicle information may include, for example, vehicle weight information, vehicle inspection information, and/or information on the types and contents of the cargo that the vehicle is transporting (e.g., consumer goods, equipment, commodities, livestock, hazardous materials, etc.). In some examples, some or all of the vehicle information may be manually entered into and stored on the vehicle's computing system by a vehicle operator or mechanic. For example, information from a prior vehicle inspection or a manual weigh station may be manually entered into the computing system. Additionally, or alternatively, some or all of the vehicle information may be collected automatically by sensors on the vehicle and then stored on the memory. For example, information obtained from tire pressure sensors or weight monitoring sensors mounted on axles of the vehicle may be automatically stored on memory.

In some examples, method 100 may leverage one or more optical codes. These optical codes may be placed at any point along a roadway, bridge, etc. where vehicle information is desired to be collected. In some examples, the optical codes may be placed prior to performing method 100, and in other examples, method 100 may include placing the optical codes at various desired locations. The optical codes may be provided on any suitable medium, for example, printed on a sign, billboard, etc. Any suitable optical codes may be used, including QR codes, bar codes, bit codes, and/or ArUco markers. By using optical codes in this manner, they can be easily implemented into existing infrastructure by states and municipalities, for example, by simply installing a sign in front of an existing weigh station.

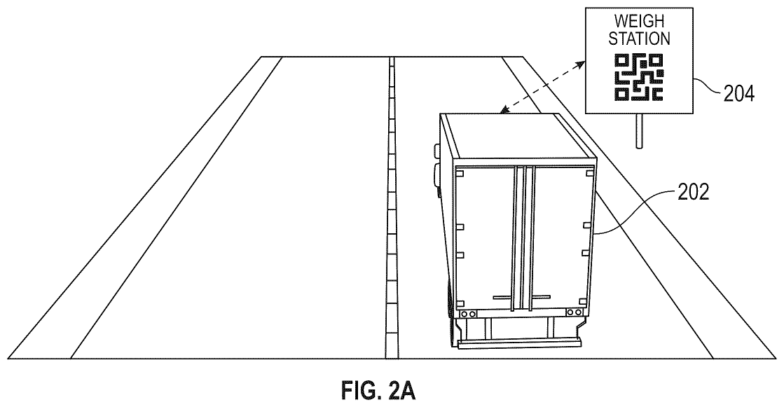

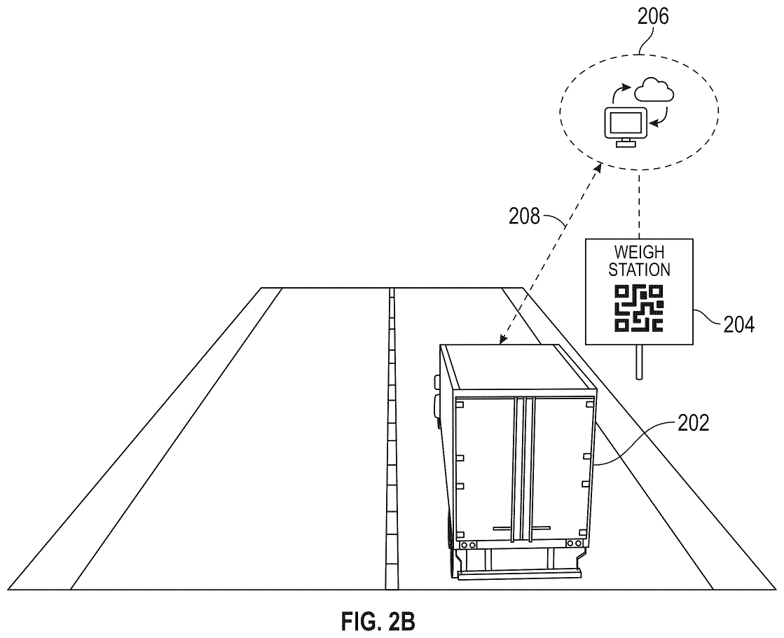

At step 104, method 100 may include detecting an optical code using one or more sensors on a vehicle. In some examples, the one or more sensors may be any standard optical sensors, such as cameras that may located on the front, side, or rear of the body of the vehicle and/or on the vehicle's mirrors. Optionally, the one or more sensors may be built into the vehicle, or they may be external sensors that are manufactured separately from the vehicle and are plugged into one or more ports within the vehicle. An example of step 104 is shown in FIG. 2A, with truck 202 detecting an optical code 204 located on the side of a road, demonstrated by the dashed arrow.

In some examples, the vehicle's computing system may be programmed to selectively detect optical codes using a certain subset of optical sensors, e.g. optical sensors at certain locations on the vehicle. For instance, in FIG. 2A, truck 202 may be configured to detect optical codes using front-facing optical sensors (not shown) for detection as the truck approaches the optical code. A vehicle may optionally be configured to detect optical codes using only front, side, and/or rear-facing optical sensors, or any combination thereof. Similarly, optical sensors on one or more of the vehicle's mirrors may be used to detect optical codes. The sensors may be configured to constantly image the vehicle's surroundings, or they may be configured to image the vehicle's surroundings at regularly spaced time or distance intervals. For example, the sensors may be configured to image the vehicle's surroundings once every quarter or tenth of a second, once every time the vehicle travels a threshold distance (e.g. once every 100 meters), or once per any given number of revolutions of the vehicle's tires.

The optical codes may include encoded information that points to, or identifies, a remote computing system with which the vehicle is to transmit information. For example, the optical code may contain a device ID, an IP address, a network location, etc. of a remote computing system associated with a weigh station, vehicle inspection station, or transportation authority, among other examples. Referring back to FIG. 1, at step 106, method 100 may include decoding this encoded information by one or more processors of the vehicle's computing system. In some examples, the vehicle's computing system may be configured to selectively decode optical codes obtained from certain sensors of the vehicle. For example, if all of the vehicle's optical sensors are configured to image the vehicle's surroundings for optical codes, the vehicle's computing system may be configured to selectively process the images captured by certain sensors in order to detect and decode optical codes. For example, only front-facing cameras (and not, e.g., rear-facing or side-facing cameras) may be used to detect optical codes. In some embodiments, a vehicle's computing system may be configured to recognize the direction in which the vehicle is traveling and may only decode the images captured by a certain subset of the optical sensors (e.g. the optical sensors that are most likely to perceive an optical code given the direction of the vehicle's travel) in order to utilize the vehicle's computing resources more efficiently.

At step 108, method 100 may include identifying a remote computing system based on the information decoded from the optical code. The vehicle's computing system may establish a communicative link with the identified computing system, for example, via a peer-to-peer connection, a cellular connection, a Bluetooth connection, or a direct wireless communication protocol. This may allow for the vehicle's computing system to transmit a signal to the remote computing system at step 110. An example of step 110 is depicted in FIG. 2B, with signal 208 illustrated as the dashed arrow between truck 202 and remote computing system 206. Signal 208 may include stored vehicle information, e.g. stored weight information or inspection information, from the vehicle to the remote computing system identified from the optical code. In this manner, a vehicle may be able to comply with vehicle information reporting laws and requirements at weigh stations, inspection stations, etc. with little to no action required on the part of the vehicle driver. In some examples, a vehicle may be configured to automatically transmit vehicle information to a remote computing system upon detecting an optical code. Additionally, or alternatively, a vehicle may be configured to transmit vehicle information in response to an input from the driver, e.g. by pressing a button or selecting a visual affordance that may be displayed on a screen in the vehicle.

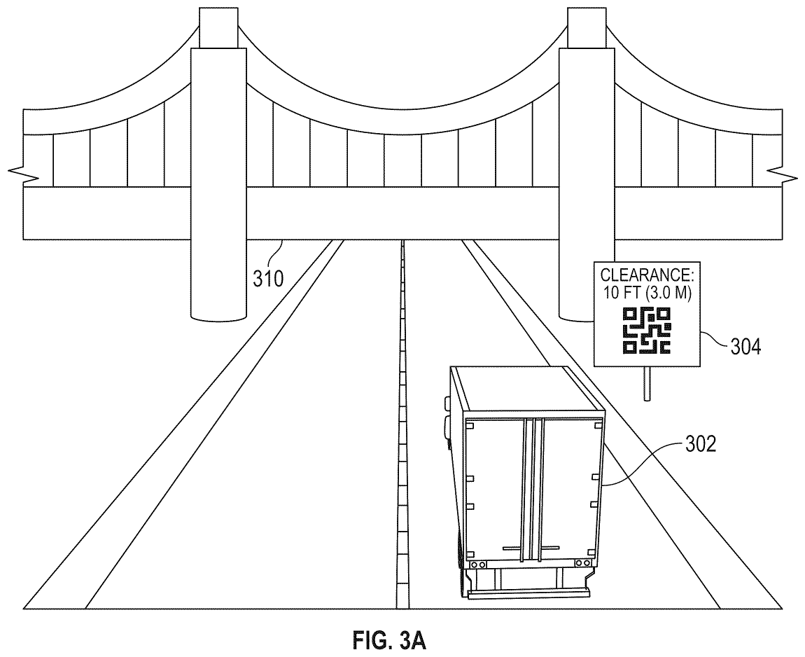

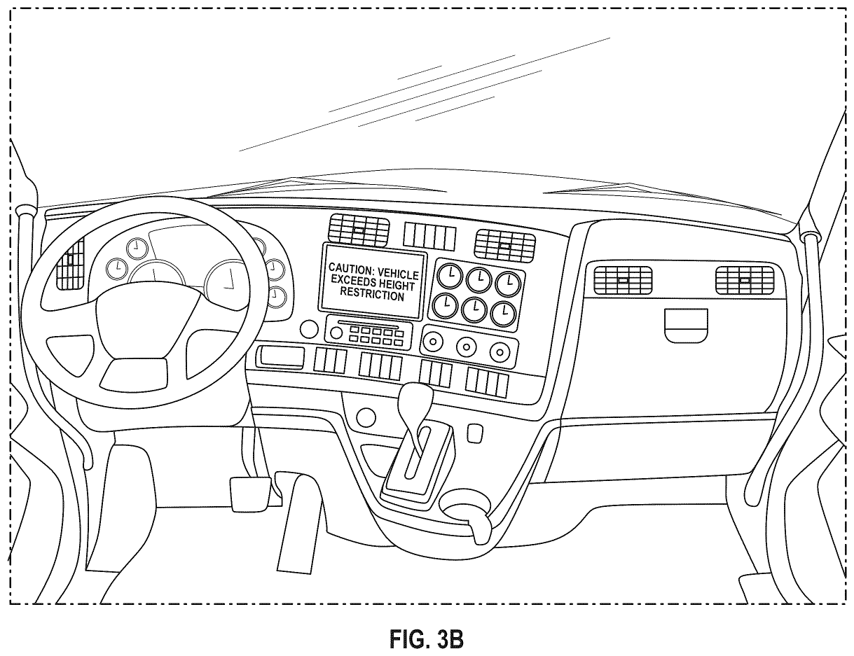

Given the versatility of optical codes, variations of method 100 may be suitable for a variety of vehicle applications, in addition to weigh stations. For example, FIG. 3A illustrates how an optical code 304 may be located near or leading up to an overpass 310. In this example, optical code 304 may be leveraged to prevent oversized vehicles from getting stuck underneath an overpass. For example, there may be height information stored on truck 302's computing system in case a driver is not aware of the exact height of the truck 302 or in case the driver fails to notice a height restriction posted on a separate sign near an overpass 310 and/or above optical code 304.

One or more optical sensors on truck 302 may detect optical code 304, which may enable the truck 302 to identify a remote computing system based on information decoded from the optical code. The remote computing system in this example may be physically and/or remotely accessible by a highway safety authority, transportation authority, or law enforcement authority, or it may be associated with a nearby vehicle inspection station. The truck 302 may then transmit a signal to the remote computing system that includes the vehicle height information. By monitoring vehicle height information received at the remote computing system, a highway safety or law enforcement authority may be alerted to oversized vehicles as they approach the overpass 310. The appropriate authority may then proceed to take preventative action, for example, by alerting the driver via a radio within the truck 302 or by dispatching law enforcement officials to pull over the truck 302 before it gets stuck.

Additionally, or alternatively, truck 302's computing system may be configured to receive, via a communicative link established with the remote computing system, a signal indicating that the truck 302 exceeds the posted height restriction. In some examples, as shown in FIG. 3B, truck 302 may be configured to display an alert to the driver in response to receiving a signal from the remote computing signal indicating that the truck 302 exceeds the height restriction. In some examples, if truck 302 has autonomous or semi-autonomous driving capabilities, truck 302 may be configured to automatically pull over, slow down, or stop in response to receiving a signal indicating that the truck exceeds the height restriction.

Although the received signal from the remote computing system contains information regarding the truck's height in the example of FIGS. 3A and 3B, such an alert system may be suitable for alerting a driver and/or an appropriate authority to other statuses of the vehicle that may be determined from the transmitted vehicle information. For example, such an alert system may be used in the weigh station example shown and described with respect to FIGS. 1-2B. Similarly, signals may be transmitted and received between a vehicle and a remote computing system that include information on the cargo that is being transported on the vehicle. Therefore, a driver may be able to comply with hazardous cargo reporting requirements by their vehicle's automatic detection of a posted optical code, and an appropriate authority may be alerted if a vehicle is transporting unpermitted cargo. In this manner, compliance with vehicle information reporting requirements may be improved, along with roadway safety and enforcement.

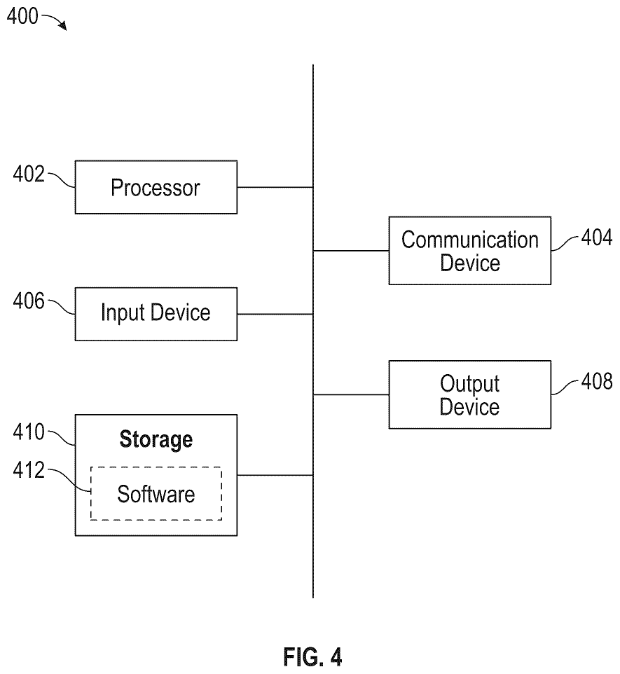

FIG. 4 depicts an exemplary device 400 that may be used for transmitting and/or receiving vehicle information in accordance with one or more examples of the disclosure. Device 400 can be a host computer connected to a network. In some examples, device 400 may be a component of a vehicle computing system and/or a remote computing system as described herein. Device 400 can be a client computer or a server. As shown in FIG. 4, device 400 can be any suitable type of microprocessor-based device, such as a personal computer, workstation, server, or handheld computing device (i.e., a portable electronic device) such as a phone or tablet. The device can include, for example, one or more of processors 402, input device 406, output device 408, storage 410, and communication device 404. Input device 406 and output device 408 can generally correspond to those described above and can either be connectable or integrated with the computer.

Input device 406 can be any suitable device that provides input, such as a touch screen, keyboard or keypad, mouse, or voice-recognition device. Output device 408 can be any suitable device that provides output, such as a touch screen, haptics device, or speaker.

Storage 410 can be any suitable device that provides storage, such as an electrical, magnetic, or optical memory, including a RAM, cache, hard drive, or removable storage disk. Communication device 404 can include any suitable device capable of transmitting and receiving signals over a network, such as a network interface chip or device. The components of the computer can be connected in any suitable manner, such as via a physical bus or wirelessly.

Software 412, which can be stored in storage 410 and executed by processor 402, can include, for example, the programming that embodies the functionality of the present disclosure (e.g., as embodied in the devices as described above).

Software 412 can also be stored and/or transported within any non-transitory computer-readable storage medium for use by, or in connection with, an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 410, that can contain or store programming for use by, or in connection with, an instruction execution system, apparatus, or device.

Software 412 can also be propagated within any transport medium for use by, or in connection with, an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by, or in connection with, an instruction execution system, apparatus, or device. The transport-readable medium can include, but is not limited to, an electronic, magnetic, optical, electromagnetic, or infrared wired or wireless propagation medium.

Device 400 may be connected to a network, which can be any suitable type of interconnected communication system. The network can implement any suitable communication protocols and can be secured by any suitable security protocols. The network can comprise network links of any suitable arrangement that can implement the transmission and reception of network signals, such as wireless network connections, T1 or T3 lines, cable networks, DSL, or telephone lines.

Device 400 can implement any operating system suitable for operating on the network. Software 412 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method of transmitting vehicle information, the method performed at least in part at a vehicle comprising one or more sensors, one or more processors, and memory, the method comprising:
storing vehicle information on the memory;
detecting, by the one or more sensors, an optical code, the optical code comprising encoded information;
decoding, by the one or more processors, the encoded information;
identifying a remote computing system based on the decoded information; and
transmitting a signal comprising the vehicle information from the vehicle to the identified remote computing system.

2. The method of claim 1, wherein the vehicle information comprises one or more of vehicle weight information, vehicle height information, cargo information, or vehicle inspection information.

3. The method of claim 1, wherein the vehicle information comprises vehicle weight information, and wherein the optical code is located on a side of a roadway or bridge.

4. The method of claim 1, wherein the vehicle information comprises vehicle height information, and wherein the optical code is located along a roadway that passes under an overpass.

5. The method of claim 1, wherein the optical code is an ArUco, a QR code, a barcode, or a bit code.

6. The method of claim 1, further comprising establishing a communicative link between the vehicle and the identified remote computing system based on the optical code.

7. The method of claim 6, wherein the communicative link is a peer-to-peer link, a cellular connection, a Bluetooth connection, or a direct wireless communication protocol.

8. The method of claim 1, further comprising receiving, by the vehicle, in response to transmitting the signal comprising the vehicle information, a signal from the remote computing system comprising status information.

9. The method of claim 8, wherein the vehicle information comprises vehicle weight information, and wherein the status information indicates that the vehicle weight exceeds a weight limitation.

10. The method of claim 8, wherein the vehicle information comprises cargo information, and wherein the status information indicates that the vehicle is carrying unpermitted cargo.

11. A system for transmitting vehicle information, the system comprising:
a vehicle comprising one or more sensors, one or more processors, and
memory storing computer program code executable by the one or more processors to cause the vehicle to:
store vehicle information on the memory;
detect, by the one or more sensors, an optical code, the optical code comprising encoded information;
decode, by the one or more processors, the encoded information;
identify a remote computing system based on the decoded information; and
transmit a signal comprising the vehicle information from the vehicle to the identified remote computing system.

12. The system of claim 11, wherein the vehicle information comprises vehicle weight information, and wherein the optical code is located on a side of a roadway or bridge.

13. The system of claim 11, wherein the vehicle information comprises vehicle height information, and wherein the optical code is located along a roadway that passes under an overpass.

14. The system of claim 11, wherein the optical code is an ArUco, a QR code, a barcode, or a bit code.

15. The system of claim 11, wherein the vehicle is further caused to establish a communicative link between the vehicle and the identified remote computing system based on the optical code.

16. The system of claim 15, wherein the communicative link is a peer-to-peer link, a cellular connection, a Bluetooth connection, or a direct wireless communication protocol.

17. The system of claim 11, wherein the vehicle is further caused to receive, in response to transmitting the signal comprising the vehicle information, a signal from the remote computing system comprising status information.

18. The system of claim 17, wherein the vehicle information comprises vehicle weight information, and wherein the status information indicates that the vehicle exceeds a weight limitation.

19. The system of claim 17, wherein the vehicle information comprises cargo information, and wherein the status information indicates that the vehicle is carrying unpermitted cargo.

20. A non-transitory computer readable storage medium storing one or more programs, the one or more programs comprising instructions, which, when executed by a vehicle comprising one or more sensors, one or more processors, and memory, cause the vehicle to:
store vehicle information on the memory;
detect, by the one or more sensors, an optical code, the optical code comprising encoded information;
decode, by the one or more processors, the encoded information;
identify a remote computing system based on the decoded information; and
transmit a signal comprising the vehicle information from the vehicle to the identified remote computing system.
